(19) United States
(12) Patent Application Publication
(10) Pub. No.: US 2014/0176902 A1
(43) Pub. Date: Jun. 26, 2014

(54) SHUTTER AND POLARIZED EYEWEAR

(71) Applicant: IpVenture, Inc., Los Altos, CA (US)

(72) Inventors: Jason Sweis, San Jose, CA (US); Vivian Liane Rice, Campbell, CA (US); David Chao, Saratoga, CA (US); Zhiyang Guo, Hercules, CA (US)

(73) Assignee: IpVenture, Inc., Los Altos, CA (US)

(21) Appl. No.: 14/190,352

(22) Filed: Feb. 26, 2014

Related U.S. Application Data
(63) Continuation-in-part of application No. 13/615,447, filed on Sep. 13, 2012.
(60) Provisional application No. 61/535,341, filed on Sep. 15, 2011.
(60) Provisional application No. 61/556,083, filed on Nov. 4, 2011.

(51) Int. Cl. G02C 7/12

(52) U.S. Cl. CPC G02C 7/12
USPC 351/159.56

(57) ABSTRACT

Apparatuses and methods of shuttering glasses are disclosed. One apparatus includes a first lens operable to blank for a first blocking time, wherein light passing through the first lens is polarized in a first orientation, a second lens operable to blank for a second blocking time, wherein light passing through the second lens is polarized in a second orientation, wherein the second orientation is different than the first orientation, and a controller for controllably setting at least one of the first blocking time and the second blocking time.

### RELATED APPLICATIONS

The patent application is a continuation-in-part to U.S. patent application Ser. No. 13/615,447, filed on Sep. 13, 2012 which claims priority to U.S. Provisional Patent Application No. 61/535,341, filed Sep. 15, 2011, and U.S. Provisional Patent Application No. 61/556,083, filed Nov. 4, 2011 which are all hereby incorporated herein by reference.

### FIELD OF THE DESCRIBED EMBODIMENTS

The described embodiments relate generally to electronic eyewear. More particularly, the described embodiments relate to apparatuses, methods and systems for shutter and polarized glasses.

### BACKGROUND

In newborn children, the nerves and brain function that control eye movement and image processing begin to converge during the first 9 months after birth. Sometimes this natural process can go wrong and their eyes can start to cross inward (esotropia) or separate outwards (exotropia). This can prevent the brain from receiving simultaneous overlapping images from each eye to provide a true 3D depth realization. Surgery is sometimes needed to bring the eyes back into reasonable alignment but the brain still may suppress one eye or the other. In other situations, though the eyes are aligned, one eye can become dominant and the other “lazy” (amblyopia). Again the brain needs to learn how to process the images from both eyes simultaneously and equally. The nerves that control the eye muscles and receive the input of each eye need to be trained such as for binocular or stereo vision.

In small children with vision problems, the best results happen if therapy is started before the age of six when the wiring becomes mostly permanent. The older the child gets, the harder it is to correct the defects. So their defective eyesight should be corrected as early as possible. However, there are challenges in working with very young children. For example, they have more difficulty comprehending the need for the therapy; and they may not be able to execute instructions for vision therapy, particularly when the tasks are boring to them. The challenge is further exacerbated when the training session requires performing certain tasks repetitively for a long duration of time.

Instead of performing vision therapy, some parents opt for corrective eye surgery. For example, surgery could bring crossed eye back into near alignment. However, even after the surgery, their brain still prefers to use one eye over another. They need to be trained or to be retrained to see with both eyes.

Such eye defects are not limited to small children. Adults may need vision therapy also. For example, according to one study, two or more percent of the population in the United States do not have stereo vision.

It is desirable to have methods, systems and apparatuses for providing vision therapy to address the eye ailments described above.

### SUMMARY OF THE INVENTION

An embodiment includes an apparatus. The apparatus includes a first lens operable to blank for a first blocking time, wherein light passing through the first lens is polarized in a first orientation, a second lens operable to blank for a second blocking time, wherein light passing through the second lens is polarized in a second orientation, wherein the second orientation is different than the first orientation, and a controller for controllably setting at least one of the first blocking time and the second blocking time.

### BRIEF DESCRIPTION OF THE DRAWINGS

FIG. 1 shows a block diagram of electronic shutter glasses according to an embodiment.

FIG. 2 shows a block diagram of electronic shutter glasses according to another embodiment.

FIG. 3 shows shutter glasses in different states of operation according to an embodiment.

FIG. 4 shows time-lines of operation of the shutter glasses for the different states shown in FIG. 3, according to an embodiment.

FIG. 5 shows time-lines of operation of the shutter glasses for the different states shown in FIG. 3, according to another embodiment.

FIG. 6 shows shutter glasses that include an adjustable level of blocking, according to an embodiment.

FIG. 7 shows shutter glasses interfaced with an external controller, according to an embodiment.

FIG. 8 is a flow chart that includes steps of a method of operating shutter glasses, according to an embodiment.

FIG. 9 shows an apparatus that includes shutter and polarization eyewear that provides polarization of images from a display that pass through lenses of the shutter and polarization eyewear, according to an embodiment.

FIG. 10 shows an apparatus that includes shutter and polarization eyewear that provides polarization of images from a display that pass through lenses of the shutter and polarization eyewear, according to another embodiment.

FIG. 11 shows an apparatus that includes shutter eyewear that includes adjustable prescription lenses, according to an embodiment.

### DETAILED DESCRIPTION OF THE INVENTION

One of the described embodiments encourages the use of both eyes simultaneously so that the brain does not suppress input from one eye. Another embodiment forces an amblyopic eye to work harder.

In one embodiment, the lenses could be LCD lenses.

One embodiment shutters the two lenses by alternately blanking the left and the right lens back and forth. For example, the shuttering speed of the lenses can be adjusted. This can be done, for example, by a knob, a slider or a small dial on the corresponding frame to program the frequency of the blanking. The switching speed can range from a few milliseconds to a short number of seconds. In another example, the switching frequency can range from 1 Hz to 15 Hz (such as in 1 Hz increment). In yet another example, the switching frequency can range from 6 to 10 Hz (such as in 0.5 Hz increment).

In another embodiment, the duty cycle of the blanking of the left and the right lens during the switching can be controlled. For example, their phase relationship can be 90 degrees, or at some other degrees. In another example, an amblyopic eye can be forced to work harder by having its corresponding lens turned on longer than the other lens. In yet another example, the shutter lenses can have different blocking times for each lens depending on which eye is more dominant or lazy.

In one embodiment, the different attributes of the shutter lenses can be programmable via switches on the corresponding frame or wirelessly via a remote control.

In one embodiment, the shutter lenses with the corresponding control circuitry and power source can be in a secondary frame, which is attachable to a primary frame via different mechanisms, such as magnets.

In one embodiment, the shutter lenses with the corresponding control circuitry and power source can be in a fit-over frame that can fit over another frame.

In one embodiment, the shutter lenses can be integrated into prescription lenses providing focal correction, such as bi-focal, tri-focal, prism, etc.

In one embodiment, the shutter lenses can auto-modulate to provide shading capability when used in sunny areas while still providing alternating vision blocking as described above.

In one embodiment, the shutter glasses are rechargeable or include power sources, such as a battery, to allow the glasses to perform its operation over a duration of time, such as a few hours.

In one embodiment, the shutter glasses may be secured from the back with a functional strap, such as a lanyard, that may contain the control circuitry and power source. This can provide additional ergonomic qualities and securing for active patients.

In one embodiment, the shutter glasses can be marketed to optometrists and ophthalmologists.

In yet another embodiment, the shutter frequency for the two lenses can be independently controlled.

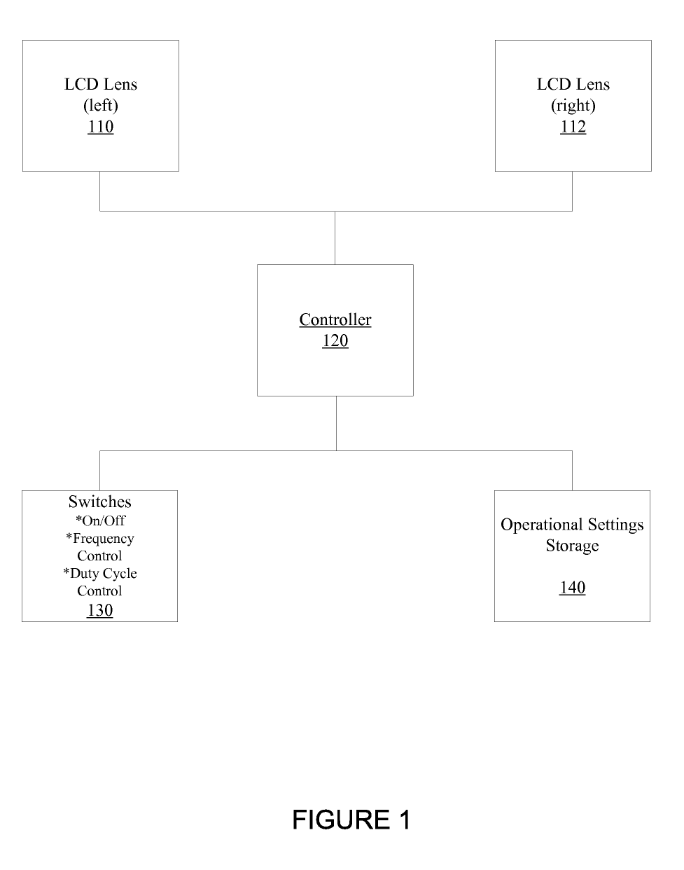

FIG. 1 shows a block diagram of electronic shutter glasses according to an embodiment. As shown, this embodiment of the shutter glasses includes a left lens 110 and a right lens 112. For an embodiment, the left lens 110 and the right lens 112 include LCD lenses.

For an embodiment, a controller 120 provides control of at least one of frequency or blocking period (blocking time) of at least one of the first lens 110 or the second lens 112. For an embodiment, the left lens 110 operable to blank for a first blocking time, the right lens operable to blank for a second blocking time, and the controller 120 controllably sets at least one of the first blocking time and the second blocking time. For an embodiment, the control of at least one of frequency or blocking period is adjustable. For an embodiment, the control of the first lens 110 is independent of the control of the second lens 112. For an embodiment, the controller 120 is at least partially controlled by switches 130 that provide at least one of on/off control, frequency control, and/or duty cycle control. For an embodiment, the frequency of the shuttering (switching from a non-block condition or state to a blocking condition or state) is the same for both lenses, but the blocking time or duty cycle of one lens is different than the blocking time or duty cycle of the other lens, thereby forcing one eye of a user to work harder than the other eye.

For an embodiment, the controller 120 is operable to access operational settings of at least the frequency and/or duty cycle from operational setting storage 140. For an embodiment, the operational settings can be adaptively updated depending upon an eye ailment a user of the shutter glasses is suffering from. Additionally, for an embodiment, the storage 140 is used for storing monitoring information that can be accessed.

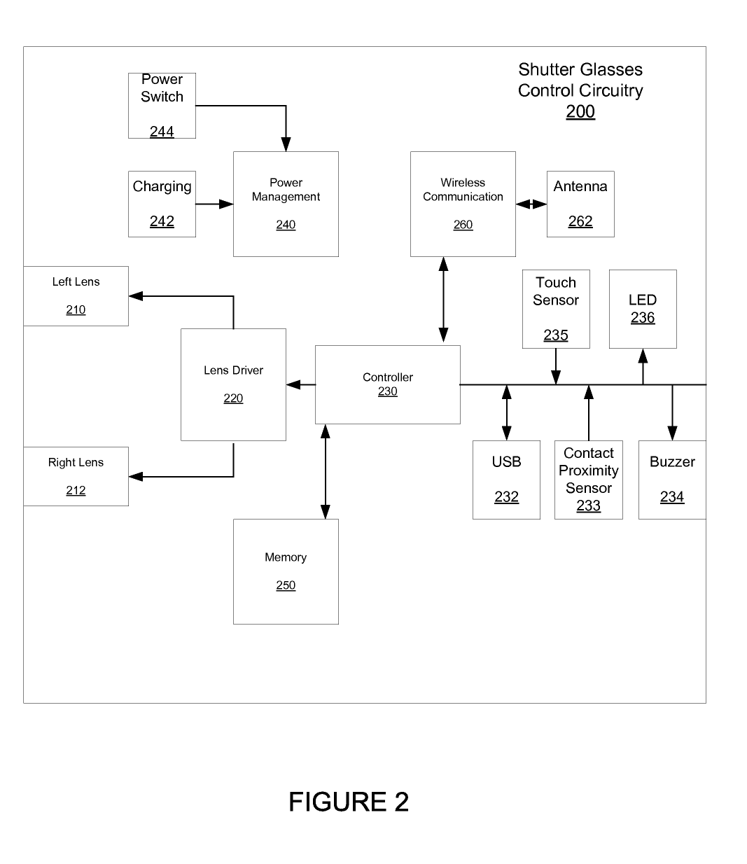

FIG. 2 shows a block diagram of electronic shutter glasses according to another embodiment. This embodiment provides examples of different types of functionality that can be included with the shuttering glasses control circuitry 200.

An embodiment includes a controller 230 that controls at least one of frequency or blocking times of at least one of a left lens 210 and a right lens 212. The controller 230 can interface with an external controller.

For an embodiment, the controller 230 interfaces with a lens driver 220 that drives states of the left lens 210 and the right lens 212. For an embodiment, the lenses 210, 212 include LCD lenses. Accordingly, for this embodiment, the lens driver is an LDC lens driver.

For an embodiment, the states of the left lens 210 and the right lens 212 include a blocking state (the lens being opaque and not letting light pass through) and a non-blocking state (the lens being transparent and letting a majority of light pass through). An embodiment includes intermediate states that allow varying amount of light pass through the lenses depending upon the intermediate state. The process of blanking includes the lenses alternating between blocking and non-blocking.

For an embodiment, the controller 230 interfaces with memory 250. For an embodiment, the controller 230 accesses from the memory 250 stored operational modes of the states of the left lens 210 and the right lens 212. For an embodiment, the controller 230 stores operational information of the shuttering glasses in the memory 250 for future access. For an embodiment, the operational information includes user usage of the shuttering glasses. For an embodiment, the operational information includes monitored or collected information of the user. The monitored information can be access by an external controller, thereby allowing determination of compliance by the user of the shutter glasses. That is, compliance by the user properly wearing the shutter glasses for a prescribed duration of time can be determined by accessed storage of wearing times and patterns by the user of the shutter glasses.

An embodiment includes power management 240 of the shuttering glasses. For an embodiment, the shuttering glasses include a battery. For an embodiment, a charging unit 242 controls charging of the battery. An embodiment includes a power switch 244. For an embodiment, the power management 240 provides and distributes electrical power to, for example, at least one of the lens driver 220, the controller 230, the memory 250, wireless communication circuitry, a touch sensor 235, an LED (light emitting diode) 236, a USB (universal serial bit) interface 232, a contact sensor 233 and/or a buzzer 234.

An embodiment includes wireless communication circuitry 260 that allows the controller 230 to communicate with an external controller. For an embodiment, wireless communication circuitry 260 is two-way in that the controller 230 can either provide the external controller with information, or the controller 230 can receive information from the external controller. An embodiment further includes an antenna 262 for enabling the wireless communication. The wireless communication can be continuous or intermittent.

An embodiment includes the touch sensor 235. For an embodiment the touch sensor 235 allows a user to communicate with the controller 230. For an embodiment, the touch sensor 235 allows the controller 230 to monitor the user of the shutter glasses.

An embodiment includes the LED 236. For an embodiment, the LED 236 allows the shutter glasses to provide visual communication to, for example, the user. For an embodiment, the LED 236 provides a visual indicator that the shutter glasses have electrical power indicating, for example, that the shutter glasses are electrically turned on.

An embodiment includes the USB port 232 for providing wired communication to or from the controller 230. For example, an external controller can communicate with the controller 230 through the USB port 232.

An embodiment includes the contact/proximity sensor 233. For an embodiment, the contact/proximity sensor 233 provides an indication that the shutter glasses are being worn. For an embodiment, the controller 230 monitors the usage (wearing of the shutter glasses) based on the contact/proximity sensor 233.

An embodiment includes the buzzer 234. For an embodiment, the buzzer 234 provides audible communication to, for example, the user. For an embodiment, the buzzer indicates to the user that the battery is low. For at least some embodiments, the buzzer is used to provide guidance to the user. For example, the buzzer can provide an indicator to the user to either take off or put the shutter glasses on.

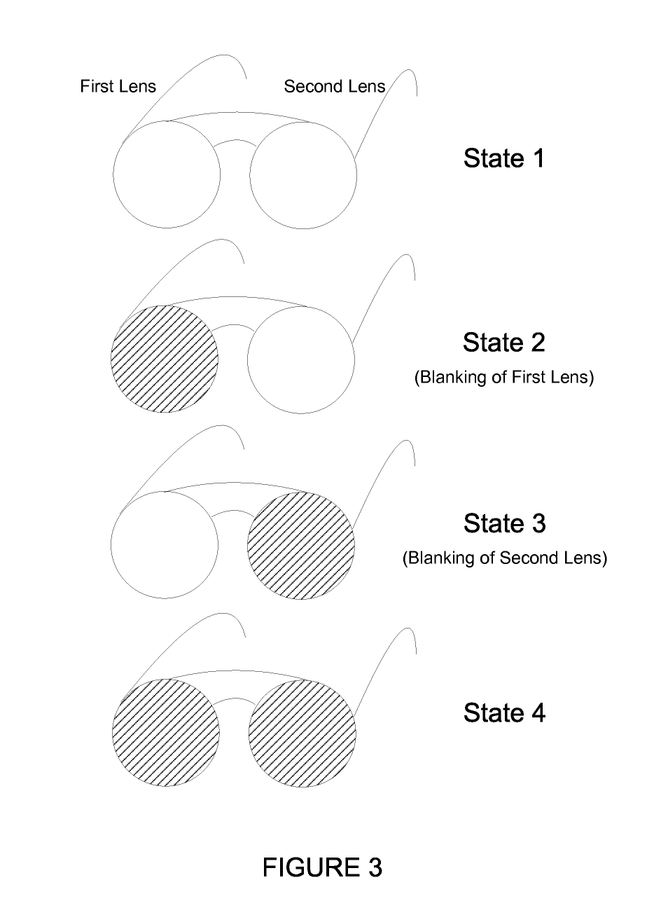

FIG. 3 shows shutter glasses in different states of operation according to an embodiment. As shown, an embodiment includes a first state wherein both a first lens and a second lens are in non-blocking. For an embodiment, a second state includes one lens (for example, the first lens) being in the blocking state, and the other lens (for example, the second lens) being in the non-blocking state. For an embodiment, a third state includes the other lens (such as, the second lens) being in the blocking state, and the lens (such as, the first lens) being in the non-blocking state. For an embodiment, a fourth state includes both lenses being in the blocking state. As described, at least some embodiments include controlling at least one of a frequency of the change from one state to at least one of the other states, or a blocking period (and conversely, the non-blocking period) of one or more of the states.

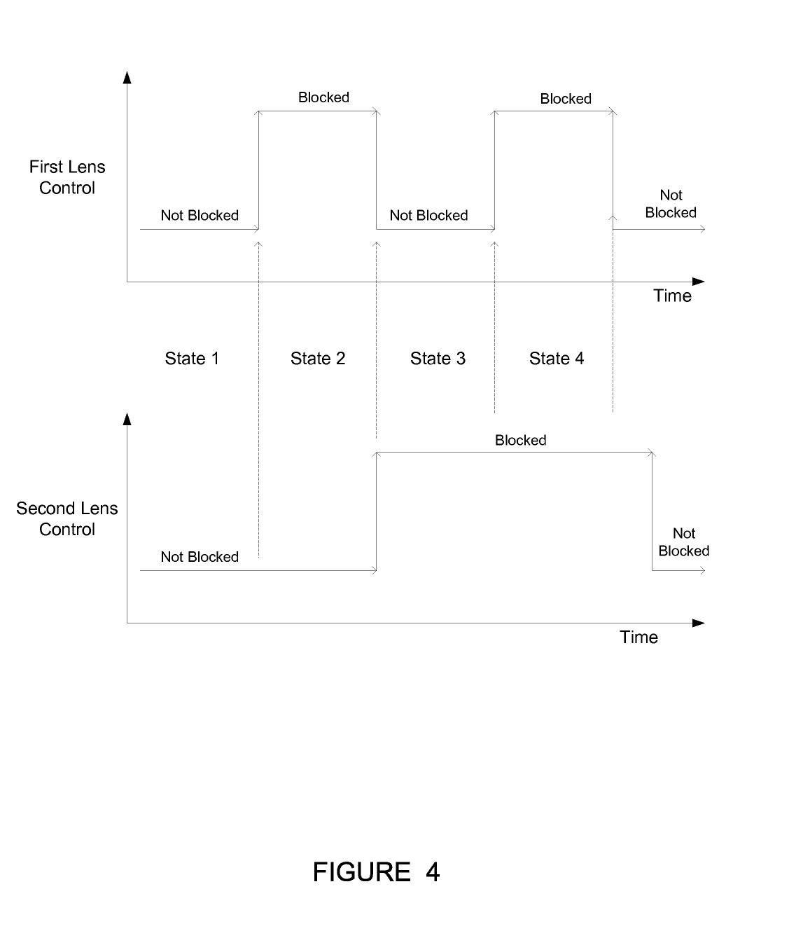

FIG. 4 shows time-lines of operation of the shutter glasses for the states shown in FIG. 3, according to an embodiment. A first time line shows control of the first lens over time between being non-blocked and blocked. A second time line shows control of the second lens over time between being non-blocked and blocked. The four possible states of FIG. 3 are shown by the time-lines of FIG. 4 according to an embodiment.

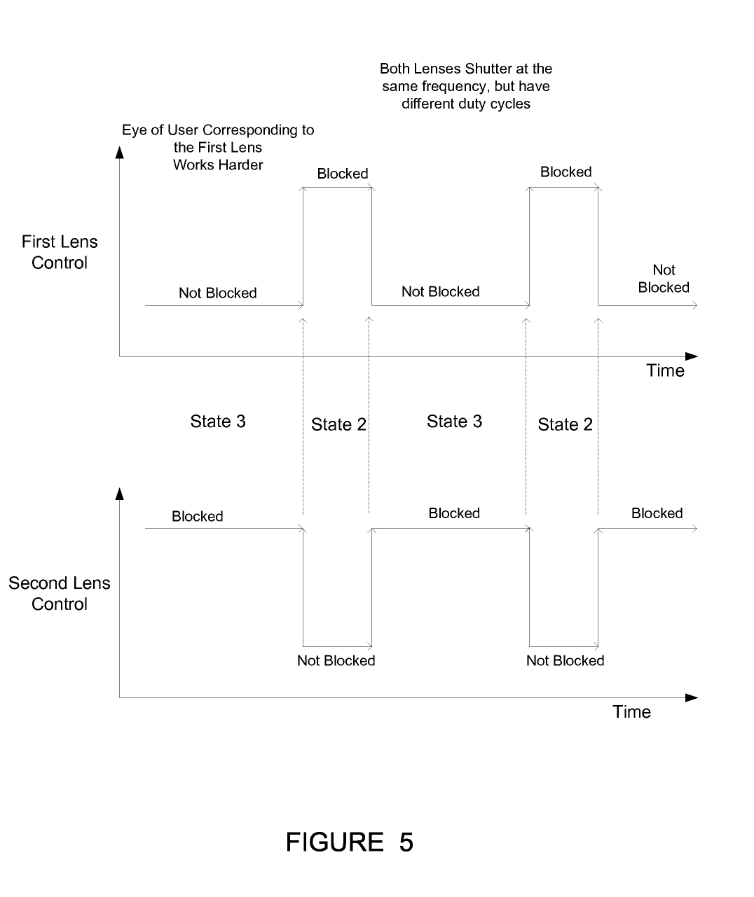

FIG. 5 shows time-lines of operation of the shutter glasses for the states shown in FIG. 3, according to another embodiment. This embodiment includes the blocking period of the first lens being less than the blocking period of the second lens while alternately blanking (blocking) the left and the right lens back and forth. For this embodiment, the frequency of the shuttering of both lenses is approximately the same. The second lens is blocking for a greater percentage of a period of the frequency of the shuttering than the first lens. Accordingly, a user of the shutter glasses is forced to use vision of the eye that corresponds with the first lens a greater percentage of time. By blocking an eye (through blanking the corresponding lens) the shutter glasses force the brain of the user to switch over to the other eye. That eye (corresponding to the lens not being blanked) is forced to align properly to see the same target of interest, and the brain continues to use that eye until the cycle repeats and switches to the other eye. The shuttering causes the user of the shutter glasses to experience a combination of muscle alignment training and anti-suppression therapy.

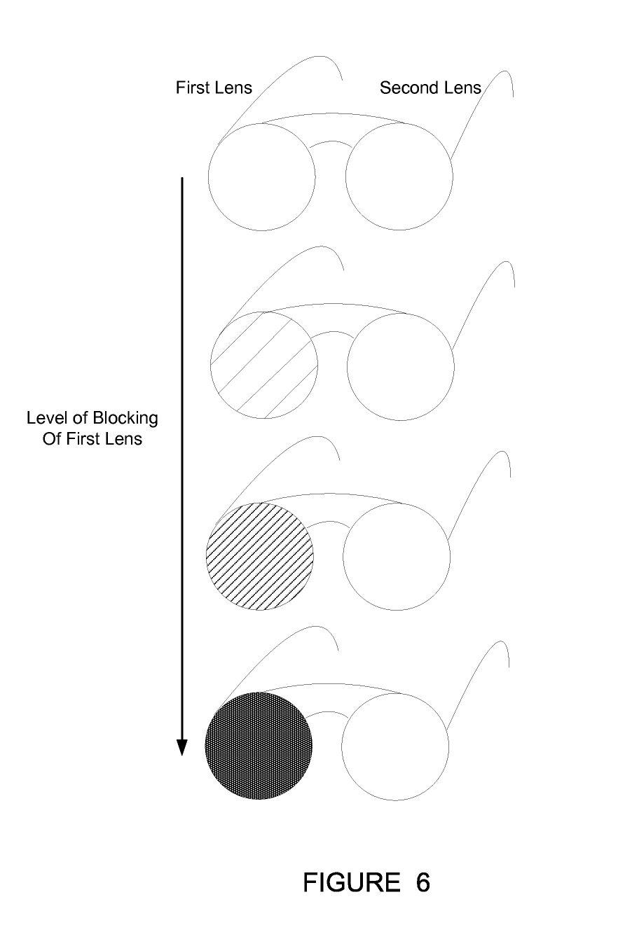

FIG. 6 shows shutter glasses that include an adjustable level of blocking, according to an embodiment. For an embodiment, the level or degree of blocking of either of the lenses is adjustable. That is, the amount of light that passes through at least one of the shuttering glasses lenses is adjustable. FIG. 6 shows the first lens of the shuttering glasses, wherein the level or degree of the blocking is adjusted from near-transparent to near-opaque, with intermediate levels or degrees of blocking in between. For at least some embodiments, the level of blocking can be increased slowly or rapidly, and then the blocking can be independently decreased slowly or rapidly. Therapy being applied to the user of the shutter glasses can dictate how to control the blocking and the levels of blocking of either lens.

At least one embodiment includes adjusting the level according to any desired sequence. For example, the level of block can be increased or decreased as desired or programmed. The level of blocking of either lens can be dependently or independently controlled.

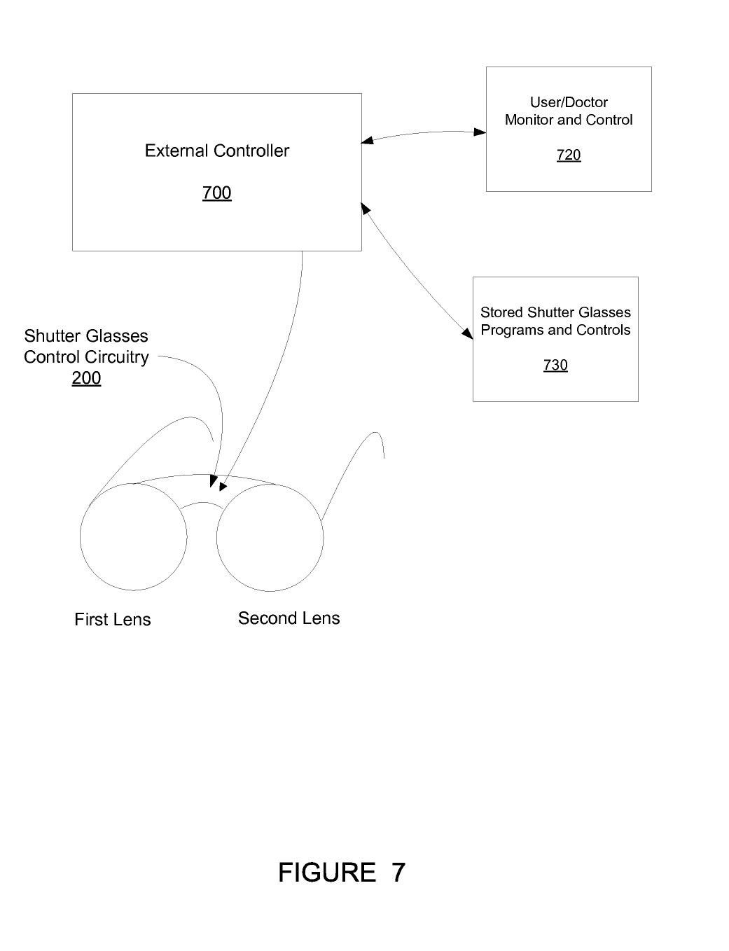

FIG. 7 shows shutter glasses interfaced with an external controller, according to an embodiment. For an embodiment, shuttering glasses control circuitry 200 is operable to communicate, for example, with an external controller 700. For an embodiment, the external controller allows a user or a doctor to monitor (720) the usage of the user. For an embodiment, the user or the doctor is able to program the shuttering glasses through the external controller 700. For an embodiment, the user or doctor can retrieve stored shuttering glasses program and controls 730. Accordingly, the doctor can proscribe therapy by programming the shutter glasses. Additionally, the doctor can monitor the use of the shutter glasses by the user (patient), thereby allowing the doctor to monitor compliance and use of the shutter glasses by the user. Further, sensors can be included that monitor activity by the user which can be stored.

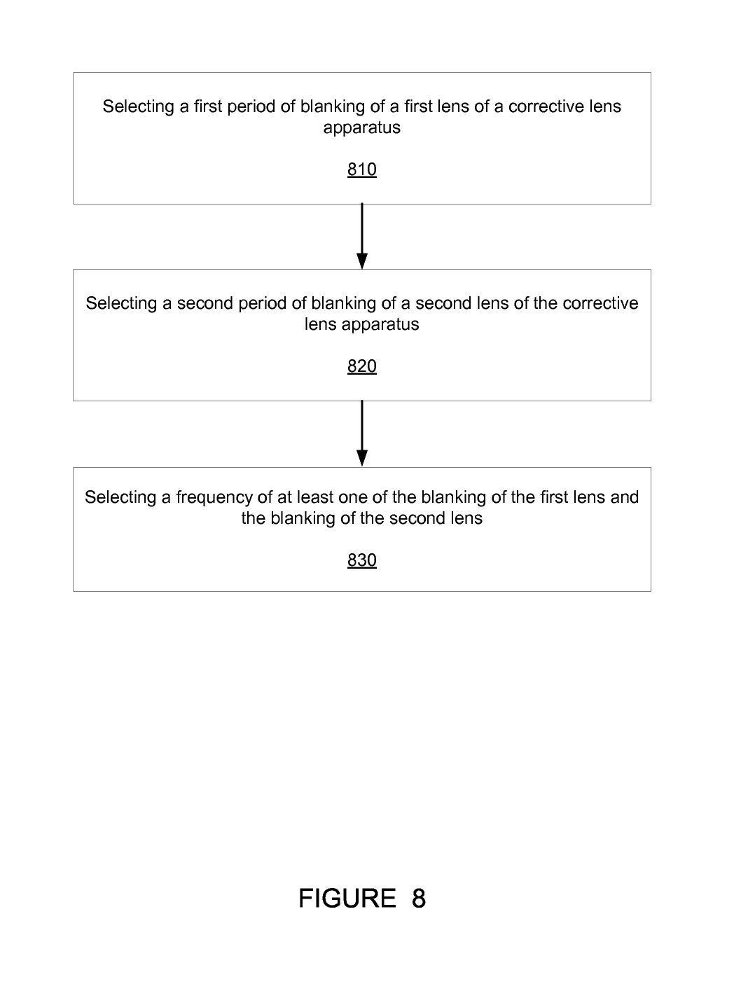

FIG. 8 is a flow chart that includes steps of a method of treating vision of a patient, according to an embodiment. A first step 810 includes selecting a first period of blanking of a first lens of a corrective lens apparatus. A second step 820 includes selecting a second period of blanking of a second lens of the corrective lens apparatus. For an embodiment, the first period and the second period are selected for treating a vision ailment of the patient. For example, the first period can be selected to be different than the second period to force one eye of the patient to work harder than the other eye of the patient. A third step 830 includes selecting a frequency of at least one of the blanking of the first lens and the blanking of the second lens. For example, particular frequencies of blanking may be determined to be more effective in treating the patient than others. For an embodiment, the frequency is selective and adjustable depending upon how the shutter glasses are programmed or set.

One embodiment of the invention encourages the use of both eyes simultaneously so that the brain does not suppress input from one eye. Another embodiment helps an amblyopic eye to work harder. Other embodiments address other issues regarding the eyes.

As previously described, in a number of embodiments, the lenses of a pair of eyewear can be shuttered, and the shutter frequency can be adjusted. For example, the two lenses can be shuttered by alternately blanking the left and the right lens back and forth, with one lens shut and the other open, and vice versa. To illustrate, the shutter frequency can range from a few milliseconds to a few seconds. In one example, the shutter frequency can range from 1 Hz to 15 Hz. In another example, the shutter frequency can range from 6 to 10 Hz. In yet another example, the shutter frequency does not exceed the frequency where the shutter can be visually perceived by an average person. As to the increment within a range, the increment can be, for example, in 0.5 Hz, 1 Hz, 2 Hz, 3 Hz, or other increments.

In at least some embodiments, various ranges of shutter frequency for one or both of the two lenses are selectable. One embodiment includes a doctor or physician (or other) selecting the range or ranges of shutter frequency based at least in part on a vision or eye ailment of a patient or user. For example, a therapy of a first ailment may be optimally provided with a first range of shutter frequencies, and a therapy of a second ailment may be optimally provided with a second range of shutter frequencies. Other factors can influence the selected range of shutter frequency as well. For example, experimentation may determine that the desired shutter frequency changes with, for example, age, time, environment, race etc. One embodiment includes a doctor or physician (or other) selecting the shutter frequency based upon the results of one or more tests performed on the patient. For example, various ranges of shutter frequency may be tested by having the patient wear a pair of shutter glasses, and while wearing the shutter glasses operating at various shutter frequencies, having the patient perform one or more tests. As illustrations, one selected range can be from one to ten hertz. Another can extend the low end of the range to a period of one or more days.

One embodiment includes sensing when the patient is actually wearing a pair of shutter glasses. This can be done, for example, by incorporating a being-worn sensor in the glasses. The sensor can determine, for example, if the temples of the glasses are in the extended position. One embodiment further includes monitoring if the user is wearing the glasses. In one embodiment, a pair of shutter glasses includes a time sensor that times at least one of how long and how frequently the patient wears the glasses. For an embodiment, the time sensor is attached to, integral with, or being a part of the shutter glasses. For an embodiment, information related to the monitoring/sensing of the glasses is stored, such as in the glasses. For an embodiment, after stored, the monitoring information can be later retrieved, for example, by a doctor or physician to allow the physician to determine or gauge the compliance (e.g. duration of time of wearing the glasses) by the patient with the therapy suggested by the doctor of physician. The retrieval can be performed wired (e.g. via an electrical connector at the glasses) or wirelessly (e.g. via an infrared sensor at the glasses).

For one embodiment, a time sensor senses when the patient puts the shutter glasses on his/her head. As described, for an embodiment, this includes a “being worn” sensor. Another embodiment includes the time sensor being activated by a triggered event, such as, pressing a button or a switch located on the glasses.

In one embodiment, a motion detector is used as the “being worn” sensor. A threshold can be set, such that if the amount of motion exceeds the threshold, the eyewear is assumed to be worn. The motion detector can, for example, be achieved by a mechanical means or an accelerometer.

In another embodiment, the “being worn” sensor includes two thermal sensors. One sensor can be at approximately the middle of a temple, such as in a region that touches the head of the user wearing the glasses. The other sensor can be at the end of the temple, close to its hinge. If the temperature differential between the two sensors is beyond a certain preset value, the eyewear would be assumed to be worn. The differential is presumed to be caused by a person wearing the pair of glasses.

In yet another embodiment, the “being worn” sensor includes a stress sensor at the hinge of the temple. The assumption is that when the eyewear is worn, the hinge is typically slightly stretched because typically, the width of the head of the user is slightly wider than the width between the temples when the two temples are in the extended positions. If the value of the stress sensor is beyond a certain preset value, the glasses would be assumed to be worn.

In a further embodiment, the “being worn” sensor can be a switch. For example, at the hinge between a temple and its corresponding lens holder, there is a switch. When that temple is fully extended outwards, the switch is turned on. The switch can be a pin. When the temple is fully extended outwards, the pin is pressed. When both temples are fully extended outwards, in one embodiment, the glasses would be assumed to be worn by the user.

In addition to monitoring pertaining to the wearing of a pair of glasses by a patient, the monitoring can include monitoring the therapies applied to the patient. In yet another embodiment, the monitoring further includes monitoring characteristics of a patient. For example, eye movement or head movements of the patient while therapy is being applied through different types of sensors in the shutter glasses. Again, the monitoring information can be stored for later retrieval. For example, a doctor or physician can retrieve the monitoring information for not only a determination of compliance by the patient, but also to obtain additional patient information obtained while the patient is wearing the glasses and being treated with therapy provided by the shutter glasses.

In one embodiment with two lenses, the shuttering of each lens is controlled by a waveform, such as a voltage waveform, and the phase relationship between the waveforms of the two lenses can be adjusted. In one example, the phase can be approximately 90 degrees. In another example, the phase relationship can be at some other degrees.

In one embodiment, the shutter frequency of the two lenses can be independently controlled.

In one embodiment, the shutter lenses described herein can also modify its transmission or tint amount. As an example, the shutter lenses can auto-modulate to provide shading capability when used in sunny areas. As another example, the amount of transmission can be reduced manually, such as via a switch at the corresponding frame, if used before a bright monitor. It has been found that in some situations, the monitor brightness is directly related to computer-inflicted eye strain. In another embodiment, the two lenses of a frame can be independently adjustable for their transmission amount.

There can be different applications to changing the transmission coefficient. One example is for amblyopic eyes. The transmission coefficient of the lens for the good eye can be reduced to a very low level, such as 10% or less, or around 5%, instead of substantially blocking all the light to the good eye. Some users may feel more comfortable if their eyes could see something, instead of having all their vision blocked.

Another application regarding tinting or mirroring the lenses of a pair of shutter glasses is to make the shuttering less conspicuous. The low-frequency shuttering of the glasses may be visible to others who are proximate to the patient, thereby potentially drawing unwanted attention to the patient. This unwanted attention may cause the patient to not wear the glasses or wear the glasses less. By tinting or mirroring the lenses of the glasses, the effects of the shuttering may be at least partially disguised, thereby reducing the potential of unwanted attention by others. The tinting or mirroring of the lenses can be realized by, for example, coating the lenses with a mirror coat. In one embodiment, such coating can be known as a flash coating or a REVO coating.

In one embodiment, the transmission coefficient of a lens is not uniform across the lens. For example, the lens can be separated into zones. Using liquid crystal as an example, a lens driver circuit can provide electrical signals to one or more zones as in addressing liquid crystal display panels. To illustrate, the zones can be columns or vertical zones. As another illustration, the zones can be rows across a lens. In yet another illustration, a zone can be a region where a row intersects a column. With columns as an example, each column can be individually addressable by its corresponding conductors to control its transmission coefficient. One application of such an implementation is to train the brain to move an eye to areas of a lens where the eye could see. Assume that each of the two lenses of a pair of glasses is separated into ten evenly-spaced columns. After detailed analysis, an optometrist decides to block light, or at least a portion of the light, coming into the left side of the left eye so as to encourage the left eye to move more towards the nose. Then the optometrist operates the lens driver circuit so that the left three columns of the left lens block off light, with the remaining seven columns allowing light to go through. In another implementation, the lens driver circuit could implement a discrete gradient change in any direction using programmable transmission for each column.

In one embodiment, the transition for shuttering is not abrupt, but is gradual. In other words, the rate of change of the transmission coefficient can be gradually, such as in a linear or sinusoidal fashion, or via other types of waveforms. In some situations, a more gradual change in the transmission coefficient, such as during shuttering, can be more soothing to the eyes.

In one embodiment where the shuttering transition is more abrupt, such as in the waveform of a substantially rectangular wave, the on/off duty cycle of the shuttering of the lenses can be controlled. In one example, the duty cycle is 50%. In another example, the duty cycle is at some other percentages. In another embodiment with two lenses, the duty cycle of each of the lenses can be independently controlled.

In one example, an amblyopic eye can be forced to work harder by having its corresponding lens turned on longer than the other lens. In another example, there can be different blocking times for each lens, depending on which eye is more dominant or lazy. In yet another example, the lens for the normal eye can be shuttered, while the lens for the amblyopic eye is left unblocked, or does not shutter.

In one embodiment with two lenses, the change in transmission characteristics of each lens is controlled by a waveform, and the waveforms for the two lenses can be different. The two waveforms can differ in frequency, transmission amount, the abruptness of the shuttering if applicable, and/or the on/off duty cycle if applicable.

In one embodiment, the one or more attributes of the shutter lenses can be programmable via one or more switches on the corresponding frame. Examples of switches on a frame can include a knob, a slider or a small dial on the corresponding frame to program, such as the frequency of the shuttering or blanking. In another example, the one or more attributes of the shutter lenses can be programmed wirelessly, such as by a remote control.

In one embodiment, the shutter lenses can be integrated into prescription lenses, providing focal correction, such as bi-focal, tri-focal, prism, etc.

In one embodiment, the shutter lenses are based on liquid crystal lens technologies.

In one embodiment, an eyewear includes a single lens. As an example, the lens could be a single wrap-around lens.

In one embodiment, a distance between each lens of, for example, a pair of shutter glasses is no less than 13 mm. That is, for shortest distance between lenses is no less than 13 mm.

In one embodiment, the electronics for the shutter lenses are in an eyewear frame with the shutter lenses. In another embodiment, the shutter lenses with the corresponding electronics, such as the control circuitry, can be in a secondary frame, which is attachable to a primary frame via different mechanisms, such as magnets. The primary frame can include a pair of prescription lenses. To illustrate, there can be a housing or a chassis holding prescription lenses, with the shutter lenses provided on the outside, such as via a clip-on. In another example, the shutter lenses with the corresponding control circuitry can be in a fit-over frame that can fit over another frame.

In one embodiment, the electronic eyewear with shutter glasses is rechargeable or includes power sources, such as a battery, to allow the glasses to perform its operation over a duration of time, such as a few hours.

In one embodiment, the shutter glasses may be secured from the back with a functional strap, such as a lanyard, that may contain the control circuitry and power source. This can provide additional ergonomic qualities and securing for active patients.

In one embodiment, the shutter glasses can be marketed to optometrists and ophthalmologists.

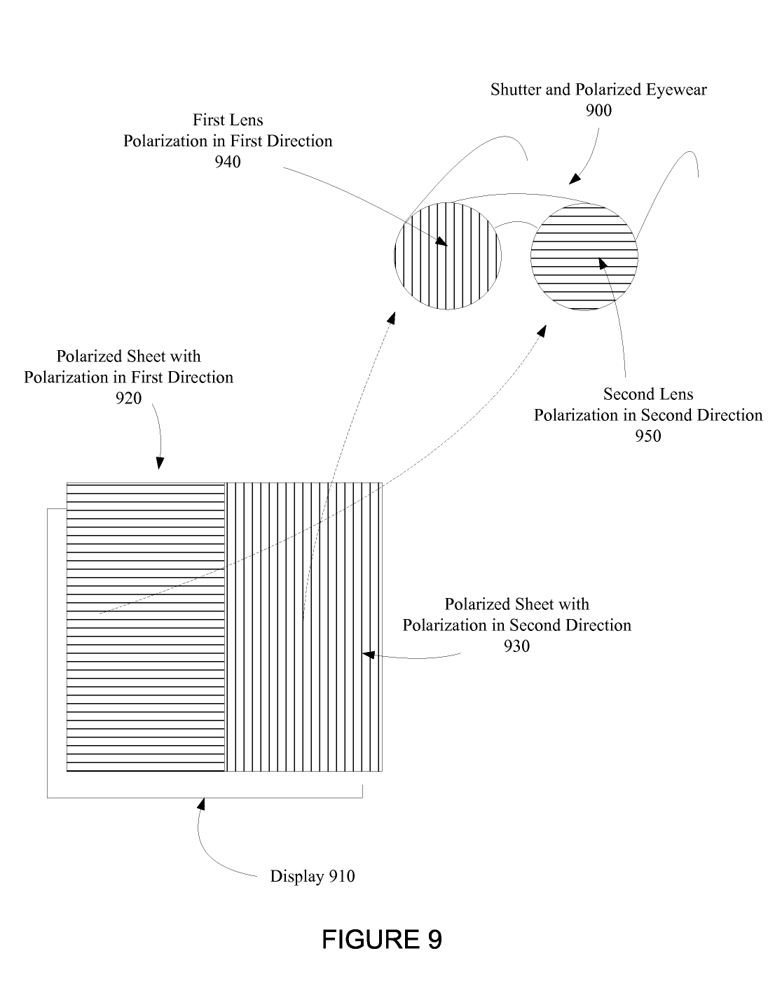

FIG. 9 shows an apparatus that includes shutter and polarization eyewear 900 that provides polarization of images from a display 910 that pass through lenses 940, 950 of the shutter and polarization eyewear 900, according to an embodiment. For an embodiment, the shutter and polarization eyewear 900 includes a first lens 940 operable to blank for a first blocking time, wherein light passing through the first lens is polarized in a first orientation, and a second lens operable to blank for a second blocking time, wherein light passing through the second lens is polarized in a second orientation, wherein the second orientation is different than the first orientation. Further, the apparatus 900 can include a controller to controllably set at least one of the first blocking time and the second blocking time.

For an embodiment, the first lens 940 includes a first polarized film having the first orientation, and the second lens 950 comprises a second polarized film having the second orientation.

For an embodiment, the first polarized film and the second polarized film include linear polarization, and wherein the first orientation includes a first direction and the second orientation includes a second direction. For an embodiment, the first direction is approximately 90 degrees relative to the second direction.

For an embodiment, the first polarized film and the second polarized film include circular polarization. For an embodiment, the first circularly polarized film delays light passing through the first lens approximately 90 degrees relative to a delay of light passing through the second circularly polarized film of the second lens. For an embodiment, the first polarized film delays light passing through the first lens approximately 90 degrees relative to a phase of light passing through the second polarized film of the second lens.

For an embodiment, the first polarized film delays light passing through the first lens approximately 90 degrees relative to a delay of light passing through the second polarized film of the second lens.

For an embodiment, at least one of the first blocking time and the second blocking time is adjusted. Such an adjustment could be used to mitigate a user from neglecting to use a lazy eye when viewing a display while wearing the apparatus.

For an embodiment, at least one of the first blocking time and the second blocking time is set to mitigate a user from neglecting to use a lazy eye when viewing a display while wearing the apparatus.

For an embodiment, the polarized film oriented in the first direction is located in adjacent proximity to the first lens, and the polarized film oriented in a second direction is located in adjacent proximity to the second lens. For an embodiment, the polarized film oriented in a first direction is affixed to the first lens, and the polarized film oriented in a second direction is affixed to the second lens. For an embodiment, the polarized film oriented in a first direction and the polarized film oriented in a second direction are clipped onto the eyewear apparatus. For an embodiment, the polarized film oriented in the first direction is embedded in the first lens, and the polarized film oriented in a second direction is embedded in the second lens.

As previously stated, for an embodiment, less light passes through the first lens when the first lens is blanking than when the first lens is not blanking, and less light passes through the second lens when the second lens is blanking than when the second lens is not blanking.

For an embodiment, the apparatus (shutter and polarization eyewear 900) is operable with a second apparatus, wherein the second apparatus includes a display 910, and a polarized sheet adjacent to the display 910, wherein the polarized sheet includes a first portion 920 having a first polarization orientation and a second portion 930 having a second polarization orientation. For an embodiment, the polarization sheet can be embedded in the display.

For an embodiment, images generated by the display 910 pass through the polarization sheet before being viewed by a user of the apparatus. For an embodiment, the first polarization orientation is approximately 90 degrees from the second polarization orientation. For an embodiment, the first portion 920 of the polarized sheet delays light passing through the first portion 920 approximately 90 degrees relative to a delay of light passing through the second portion 930 of the polarized sheet. For an embodiment, the first portion 920 of the polarized sheet delays light passing through the first lens approximately 90 degrees relative to a phase of light passing through the second portion 930 of the polarized sheet.

At least some of the described embodiments overcome lazy eye suppression. The described embodiments for providing blanking (blocking) of light passing though the lenses of eyewear encourage eyes of a user of the eyewear to exercise. Eventually a weak eye of a user should become stronger. As a side note, though some users have lazy eye suppression, they are not aware that they are suppressing.

In one approach, after the patient (user) knows how to actively avoid suppression and can practice strengthening the use of the lazy eye, the user can work on “fusing”. Fusing is the act of merging the images in the brain to create 3D depth, color blending, etc. It's typically what “normal” seeing people take for granted. The flicker (blanking) glasses can help teach fusing.

In one approach, once fusion has been achieved, the patient (user) can work on cross-eyed therapy. Typical therapy includes, for example, the use of prisms or corrective surgery to align the eyes. However, a number of described embodiments offer different alternatives. For example, described embodiments provide the patient (user) with suppression awareness and correction. Further, described embodiments provide fusion and alignment. The blanking can provide the user with the “suppression awareness”.

For an embodiment, the flicker (blanking) eyewear includes polarized films backed, and/or supported by, or embedded in liquid crystal. For an embodiment, LCD lenses are constructed with polarized films. For an embodiment, existing polarized films of LCD lenses are utilized by rotating the polarized film of one of the lenses by approximately 90 degrees relative to the another polarized film of the other one of the lenses. For the user looking at natural objects, typically, nothing will change and the user will still see the flickering (blanking of the lenses). However, at least some embodiments additionally include a polarized sheet, such as the sheet 930, which can be used as an accessory to the eyewear for viewing a display. That is, the polarized sheet can cover the display (screen). Further, for an embodiment, the polarized sheet is divided in half with the one half having one polarizing direction, and the other half with a rotated approximately 90 degrees polarizing direction. Therefore, when the user looks through the eyewear using one eye, the user sees the first half the screen while the second half is blacked out. When the user looks through the eyewear with the other eye, the user sees the second half of the display, with the first half blacked out. Utilization of the polarization sheet and the polarization eyewear does not require changing the colors of the screen (display), and therefore, a second observer of the display who is not wearing the eyewear can still enjoy the image content (such as a movie) along the patient.

At least some of the described embodiments allow the user to only see half of the display (screen) if the user starts to suppress in any eye. This makes the user aware of the weak eye, which the user can then correct. At least one advantage provided by the described embodiments with lenses polarized in different directions is that the user can tilt his/her head, such as about 10-15 degrees, to defeat the polarization effect of the eyewear. Therefore, the patient (user) has the option to take breaks if needed.

For an embodiment, a frequency in which at least one of the first lens and the second lens alternates between blocking and non-blocking is adjustable. For an embodiment, the frequency is randomly selected. If the frequency of the blocking versus non-blocking of the lenses is maintained at a constant rate, the user may fatigue and the therapy can lose effectiveness. However, with the frequency changing, the user is less likely to become fatigued, leading to more effective therapy. In other words, random selection of the frequency or preselected patterns of the frequency can mitigate fatigue of the user.

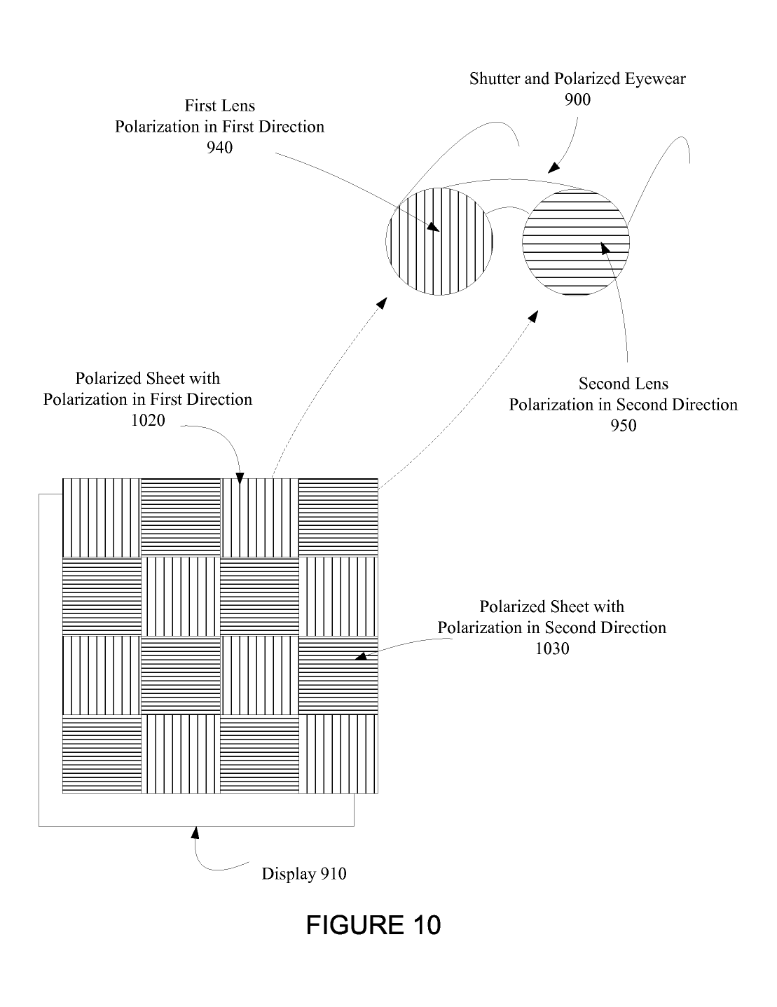

FIG. 10 shows an embodiment of an apparatus that includes shutter and polarization eyewear 900. The eyewear 900 can provide polarization of images from a display 910 when the images pass through lenses 940, 950 of the shutter and polarization eyewear 900. As shown, the polarized sheet includes a plurality of sections 1020 polarized, for example, in a first polarization orientation, and another plurality of sections 1030 polarized in a second polarization orientation.

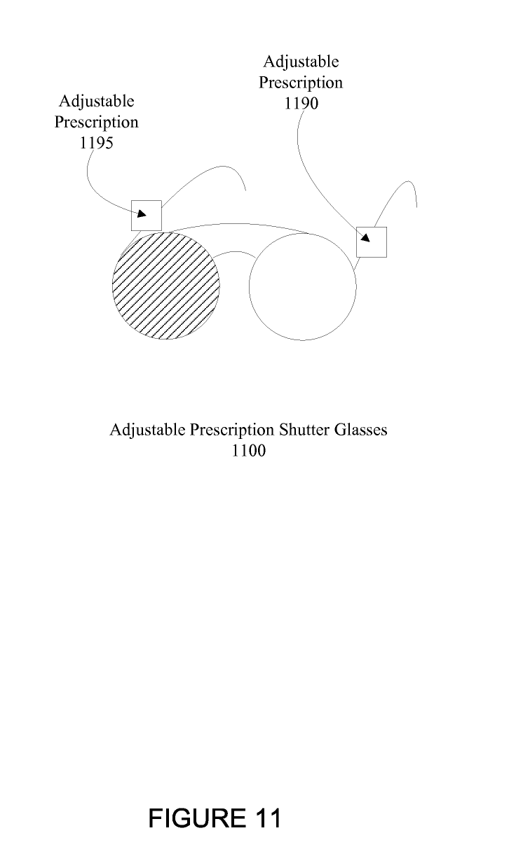

FIG. 11 shows an apparatus that includes shutter eyewear 1100 with adjustable prescription lenses, according to an embodiment. During therapy, the eyesight of the user may change. For example, the eyesight of the user may improve. For an embodiment, the shutter and polarization eyewear includes prescription lenses. For an embodiment, the shutter and polarization eyewear includes prescription lenses wherein the prescription is adjustable, allowing the therapy to adapt to changing eyesight of the user. FIG. 11 shows prescription adjusters 1190, 1195 located at temples of the eyewear according to an embodiment.

Fluctuations or changes in a user's vision can occur during therapy. An embodiment includes adjusting the prescription of prescription lenses of the shutter eyewear to account for the possible fluctuation or changes in the user's prescription during the shuttering and polarization therapy. That is, the therapy can cause the user's eyesight to improve, and the adjustable prescription lenses can account for these changes (improvement).

At least some embodiments include adjusting the power of one or more lenses to enable the user to see in clear focus. Additionally, an embodiment includes recording the changes in the user's prescription.

For an embodiment, adjusting the power of a variable power lens can be automatic. For an embodiment, the prescription lenses of the shutter eyewear or the shutter and polarization eyewear include an onboard auto-refractor. For an embodiment, adjusting the power of the variable power lens includes allowing a user adjustment of the power of the variable power lens. This allows for rapid and accurate ways to achieve the users ideal prescription settings.

The ability to adjust the optical power of a lens could provide a “one size fits all” device, allowing a user to adjust as necessary to suit the user's optical prescription. For example, the user first adjusts the optical power of a lens to suit the user's refractive state. Then when changes in the refractive state of the corresponding eye become apparent, the user could further adjust the lens to be able to see with clear focus again. Alternatively the user can periodically adjust the optical power of the lenses to suit their refractive state as part of a simple refraction protocol. For an embodiment, the protocol is a set of instructions including a Snellen chart given to a user by a clinician so that the user can change the optical power of the lenses until the user can see a particular line on the Snellen chart. For an embodiment, the protocol is a set of instructions to change the optical power of the lenses by a certain amount at certain times throughout the day. This allows the lenses not to be fixed or custom-made, but can be adjusted by the user as necessary. The variable power lens also enables multiple users with different optical prescriptions to use the same apparatus. This could be of benefit in an environment such as a hospital where viewing equipment may be used by many different patients.

For an embodiment, a single lens is provided for both eyes. For another embodiment, separate lenses are provided for each eye. For an embodiment, a single adjustment for the two lenses is provided. In these embodiments the two lenses are therefore linked or coupled such that a single adjustment can be made to alter the power of both lenses simultaneously. For another embodiment, separate adjustment for each lens is provided. This enables users who require different power of lens correction for each eye to be able to adjust the two lenses individually to suit their prescription which may be different for each eye.

For an embodiment, variable power lens could be, for example, a fluid filled lens, an Alvarez-based lens, an electroactive lens, a diffractive lens or a diffractive Alvarez lens.

For an embodiment, the optical-power adjustment range is large enough to be suitable for a large proportion of the population. A large spherical power range, e.g. of +/−8 D, enables the apparatus (shuttering eyewear) to be suitable for a vast majority of the population, although a narrower range, e.g. +/−4D, could be sufficient to cover a relatively large proportion of the population also.

For at least some embodiments, different types of variable power lenses are arranged to be able to provide a large adjustment range. In the set of embodiments in which a fluid filled lens is provided, a large adjustment range can be provided. In some embodiments it may be necessary to include a double membrane structure, such as an optically transparent cavity closed off on both sides by flexible membranes, for the fluid cavity. This allows the optical power range to be shared between two surfaces, which could prevent creep and other plastic deformation. A double membrane structure may also require some form of protection or cover for the membranes, unless the membrane's own toughness or hardness is sufficient to protect it from damage. Otherwise, dents in the membrane could be a problem. In other embodiments a single membrane structure (an optically transparent cavity closed off on one side by a flexible membrane) is able to provide a large enough adjustment range. Again, a single membrane structure may require some form of protection or cover over the membrane.

For embodiment in which an Alvarez lens is provided, a large adjustment range could be possible. For a given shape of the Alvarez lens, a greater adjustment range typically requires a greater translational distance and as a result wider lens elements to maintain a useable viewing area through overlapping elements.

For at least some embodiments in which a fluid filled lens is provided, the fixed power prescription element(s) includes the protective cover(s) for the lens, e.g. if a double membrane lens was being used or as a cover for a single membrane lens. Alternatively it could be attached to the cavity wall or it could comprise the cavity wall opposite a membrane if a single membrane lens is being used. This latter option typically does not need to add an extra optical component to the lens. A cavity wall is usually needed in a single membrane lens, so it may be advantageous that this comprises a fixed power prescription element. Providing a prescription element can help to reduce the total range of the variable power lens, which in a fluid filled lens implies requiring less fluid, helping to reduce the size of the lens. It is typically also easier to manufacture a single membrane lens than a double membrane lens.

Although specific embodiments have been described and illustrated, the embodiments are not to be limited to the specific forms or arrangements of parts so described and illustrated. The embodiments are limited only by the appended claims.

What is claimed is:

1. An apparatus, comprising:
a first lens operable to blank for a first blocking time, wherein light passing through the first lens is polarized in a first orientation;
a second lens operable to blank for a second blocking time, wherein light passing through the second lens is polarized in a second orientation, wherein the second orientation is different than the first orientation; and
a controller for controllably setting at least one of the first blocking time and the second blocking time.

2. The apparatus of claim 1, wherein the first lens comprises a first polarized film having the first orientation, and the second lens comprises a second polarized film having the second orientation.

3. The apparatus of claim 2, wherein the first polarized film and the second polarized film include linear polarization, and wherein the first orientation includes a first direction and the second orientation includes a second direction.

4. The apparatus of claim 3, wherein the first direction is approximately 90 degrees relative to the second direction.

5. The apparatus of claim 2, wherein the first polarized film and the second polarized film include circular polarization.

6. The apparatus of claim 5, wherein the first polarized film delays light passing through the first lens approximately 90 degrees relative to a delay of light passing through the second polarized film of the second lens.

7. The apparatus of claim 1, wherein at least one of the first blocking time and the second blocking time is adjusted to mitigate a user from neglecting to use a lazy eye when viewing a display while wearing the apparatus.

8. The apparatus of claim 1, wherein at least one of the first blocking time and the second blocking time is set to mitigate a user from neglecting to use a lazy eye when viewing a display while wearing the apparatus.

9. The apparatus of claim 2, wherein the polarized film oriented in the first direction is located in adjacent proximity to the first lens, and the polarized film oriented in a second direction is located in adjacent proximity to the second lens.

10. The apparatus of claim 9, wherein the polarized film oriented in a first direction is affixed to the first lens, and the polarized film oriented in a second direction is affixed to the second lens.

11. The apparatus of claim 9, wherein the polarized film oriented in a first direction is affixed to the first lens, and the polarized film oriented in a second direction is affixed to the second lens.

12. The apparatus of claim 9, wherein the polarized film oriented in a first direction and the polarized film oriented in a second direction are clipped onto the apparatus.

13. The apparatus of claim 1, wherein less light passes through the first lens when the first lens is blanking than when the first lens is not blanking, and less light passes through the second lens when the second lens is blanking than when the second lens is not blanking.

14. The apparatus of claim 1, wherein the apparatus is operable with a second apparatus, wherein the second apparatus comprises:
a display;
a polarized sheet adjacent to the display, wherein the polarized sheet includes a first portion having the first polarization orientation and a second portion having the second polarization orientation.

15. The apparatus of claim 14, wherein images generated by the display pass through the polarization sheet before being viewed by a user of the apparatus.

16. The apparatus of claim 14, wherein the first polarization orientation is approximately 90 degrees from the second polarization orientation.

17. The apparatus of claim 14, wherein the polarized sheet comprises a plurality of sections that are polarized in the first polarization orientation, and another plurality of sections that are polarized in the second polarization orientation.

18. The apparatus of claim 1, wherein a prescription of at least one of the first lens and the second lens is adjustable.

19. The apparatus of claim 18, wherein during the first blocking time, the first lens substantially prevents light from passing through the first lens, and during the second blocking time, the second lens substantially prevents light from passing through the second lens.

20. The apparatus of claim 18, wherein when not operating within the first blocking time, the first lens substantially allows light to pass through the first lens, and when not operating within the second blocking time, the second lens substantially allows light to pass through the second lens.

21. The apparatus of claim 18, wherein a frequency in which at least one of the first lens and the second lens alternates between blocking and non-blocking is adjustable.

22. The apparatus of claim 21, wherein the frequency is randomly selected.

23. The apparatus of claim 2, wherein a frequency in which the first lens alternates between blocking and non-blocking is within a range of 1 Hz to 15 Hz.

24. The apparatus of claim 1, wherein the first blocking time and the second blocking time are selected to force an eye of a user of the apparatus to work harder than another eye of the user.
